(19) United States
(12) Patent Application Publication
(10) Pub. No.: US 2018/0054383 A1
(43) Pub. Date: Feb. 22, 2018

(54) DSP INTERFACE APPARATUS AND CONTROL METHOD FOR THE SAME

(71) Applicant: SAMSUNG ELECTRONICS CO., LTD., Suwon-si (KR)

(72) Inventors: Won Chang LEE, Seongnam-si (KR); Joon Ho SONG, Hwaseong-si (KR); Yong Seok CHOI, Seoul (KR)

(21) Appl. No.: 15/678,326

(22) Filed: Aug. 16, 2017

(30) Foreign Application Priority Data
Aug. 16, 2016 (KR) 10-2016-0103743

(51) Int. Cl. H04L 12/725; H04Q 11/00

(52) U.S. Cl. CPC H04L 45/30; H04L 45/24; H04Q 11/00

(57) ABSTRACT

A digital signal processor (DSP) interface apparatus capable of variably setting an interconnection between a DSP and a plurality of hardware devices and a method of controlling the same are provided. The DSP interface apparatus includes a path setter configured to set a data transmission path between at least one of a plurality of hardware devices and a DSP; and a controller configured to control the path setter to set the data transmission path by connecting at least one of a plurality of operation parts and a memory of the DSP and at least one of the plurality of hardware devices based on predetermined configuration information.

### CROSS-REFERENCE TO RELATED APPLICATION

This application is based on and claims priority under 35 U.S.C. §119 to Korean Patent Application No. 10-2016-0103743, filed on Aug. 16, 2016 in the Korean Intellectual Property Office, the disclosure of which is incorporated by reference herein in its entirety.

### BACKGROUND

### 1. Field

The present disclosure relates generally to a digital signal processor (DSP) interface apparatus capable of controlling an input and an output of a DSP which processes data, and a method of controlling the same.

### 2. Description of Related Art

A digital signal processor (DSP) is a microprocessor having an integrated circuit (IC) chip which processes data through a digital operation. The DSP may be realized by improving general-purpose microprocessor architecture to a large extent to increase high-speed operation capability, simplify a structure, and decrease a size.

Generally, a DSP may perform operations such as filtering, Fourier transformation, calculation of a correlation function, coding, modulation/demodulation, differentiation, integration, adaptive signal processing, etc. Thus, a DSP has recently been employed in voice and communication systems related to voice synthesis, voice recognition, speech coding, compression, a medium/high-speed modem, an echo canceler, etc. Furthermore, a DSP has been extensively used in the field of high-speed digital control, including image processing, servo-motor control, etc.

As a DSP has been used in many ways, the number and types of hardware devices to be connected to the DSP have been increased. Thus, research has been actively conducted to provide an environment in a DSP may output best results under various conditions.

### SUMMARY

Therefore, it is an example aspect of the present disclosure to provide a digital signal processor (DSP) interface apparatus capable of variably setting an interconnection between a DSP and a plurality of hardware devices, and a method of controlling the same.

Additional aspects of the disclosure will be set forth in part in the description which follows and, in part, will be apparent from the description.

In accordance with an example aspect of the present disclosure, a DSP interface apparatus includes a path setter comprising path setting circuitry configured to set a data transmission path between at least one of a plurality of hardware devices and a DSP; and a controller configured to control the path setter to set the data transmission path based on predetermined configuration information.

The path setter may connect at least one of a plurality of operation parts and a memory of the DSP and at least one of the plurality of hardware devices.

The controller may control the path setter to set the data transmission path using the configuration information, the configuration information including at least one of: information regarding priorities assigned to the plurality of hardware devices, information regarding type of the data transmitted through the data transmission path, and information regarding whether data is to be transmitted bidirectionally.

The path setter may set a first transmission path through which data is transmitted from the DSP to at least one of the plurality of hardware devices, and a second transmission path through which data is transmitted from at least one of the plurality of hardware devices to the DSP.

The path setter may include various path setting circuitry including, for example, and without limitation, a first multiplexer configured to select at least one of the plurality of operation parts and the memory of the DSP to provide data to the first transmission path; a first demultiplexer configured to select at least one of the plurality of hardware devices to receive data from the first transmission path; a second multiplexer configured to select at least one of the plurality of hardware devices to provide data to the second transmission path; and a second demultiplexer configured to select at least one of the plurality of operation parts and the memory of the DSP to receive data from the second transmission path.

The path setter may include a first buffer configured to store data transmitted through the first transmission path; and a second buffer configured to store data transmitted through the second transmission path.

The controller may control the first buffer and the second buffer to provide data when data is stored to a predetermined target level.

The path setter may include a first data transformation part comprising data transformation circuitry configured to transform data transmitted through the first transmission path; and a second data transformation part configured to transform data transmitted through the second transmission path.

The controller may control the path setter to transmit data independently through the first transmission path and the second transmission path.

The path setter may set a plurality of first transmission paths and a plurality of second transmission paths, a plurality of first transmission paths and a second transmission path, or a first transmission path and a plurality of second transmission paths.

In accordance with another example aspect of the present disclosure, a method of controlling a DSP interface apparatus for setting a data transmission path between at least one of a plurality of hardware devices and a DSP includes setting the data transmission path based on predetermined configuration information; and transmitting data through the data transmission path.

The setting of the data transmission path includes connecting at least one among a plurality of operation parts and a memory of the DSP and at least one among the plurality of hardware devices

The setting of the data transmission path may include setting the data transmission path using the configuration information, the configuration information including at least one of: information regarding priorities assigned to the plurality of hardware devices, information regarding type of the data transmitted, and information regarding whether data is to be transmitted bidirectionally.

The setting of the data transmission path may include setting a first transmission path through which data is transmitted from the DSP to at least one of the plurality of hardware devices, and a second transmission path through which data is transmitted from at least one of the plurality of hardware devices to the DSP.

The setting of the data transmission path may include selecting at least one of the plurality of operation parts and the memory of the DSP using a first multiplexer to provide data to the first transmission path; selecting at least one of the plurality of hardware devices using a first demultiplexer to receive data from the first transmission path; selecting at least one of the plurality of hardware devices using a second multiplexer to provide data to the second transmission path; and selecting at least one of the plurality of operation parts and the memory of the DSP using a second demultiplexer to receive data from the second transmission path.

The transmitting of the data may include storing at least one of data transmitted through the first transmission path and data transmitted through the second transmission path.

The transmitting of the data may include providing the stored data when a size of the stored data reaches a predetermined target level.

The transmitting of the data may include transforming at least one of data transmitted through the first transmission path and data transmitted through the second transmission path.

The transmitting of the data may include transmitting data independently through the first transmission path and the second transmission path.

The setting of the data transmission path may include setting a plurality of first transmission paths and a plurality of second transmission paths, a plurality of first transmission paths and a second transmission path, or a first transmission path and a plurality of second transmission paths.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example digital signal processor (DSP) system in a data transmission path, in accordance with an example embodiment;

FIG. 2 is a block diagram illustrating a general DSP system;

FIG. 3 is a block diagram illustrating an example method of sharing data between a DSP and a hardware device in a general DSP system;

FIG. 4 is a block diagram illustrating an example DSP system having a DSP interface apparatus in accordance with an example embodiment;

FIG. 5 is a diagram illustrating an example operation of a DSP interface apparatus in accordance with an example embodiment;

FIG. 6 is a block diagram illustrating an example path setter of a DSP interface apparatus in accordance with an example embodiment;

FIG. 7 is a block diagram illustrating an example data transmission method, performed by a DSP interface apparatus, in accordance with an example embodiment;

FIG. 8 is a block diagram illustrating an example data transmission method, performed by a DSP interface apparatus, in accordance with another example embodiment;

FIG. 9 is a flowchart illustrating an example method of controlling a DSP interface apparatus in accordance with an example embodiment; and

FIG. 10 is a flowchart illustrating an example method of controlling a DSP interface apparatus in accordance with another example embodiment.

### DETAILED DESCRIPTION

Hereinafter, a digital signal processor (DSP) interface apparatus and a method of controlling the same in accordance with various example embodiments of the present disclosure will be described in greater detail with reference to the accompanying drawings. In the present disclosure, “transforming” of data may, for example, include handling the data, transforming the data, processing the data, manipulating the data, or the like, but is not limited thereto.

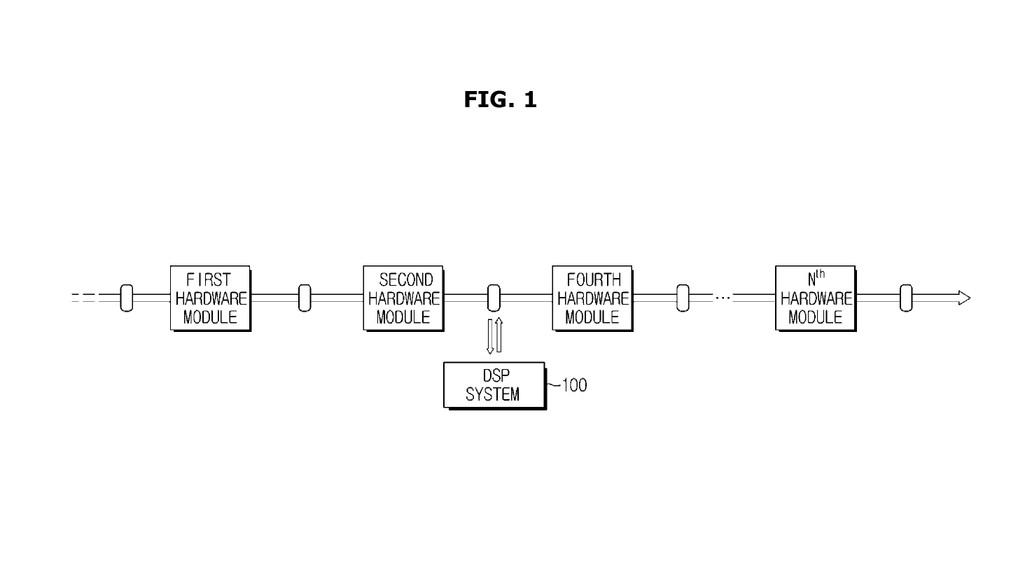

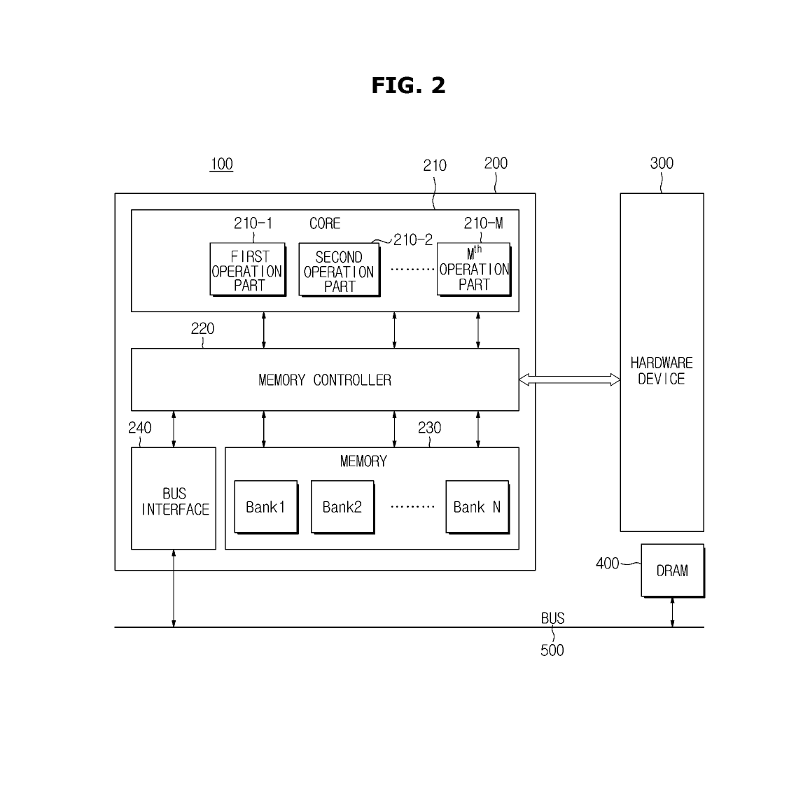

FIG. 1 is a diagram illustrating an example DSP system 100 in a data transmission path, in accordance with an example embodiment. Here, a first hardware module, a second hardware module, . . . , an n^{th} hardware module may refer, for example, to modules embodied similar to a hardware device 300 of FIG. 2 to transform input data. ‘n’ represents an integer greater than or equal to ‘3’. An arrow represents a data transmission path.

Referring to FIG. 1, in an electronic device, a plurality of hardware modules may be located in the data transmission path. Each of the hardware modules may transform data input thereto and output the transformed data. The data output from each of the hardware modules may be input data of a subsequent hardware module.

For example, when the electronic device is a television (TV), hardware modules embodied similar to the hardware device 300 (see, e.g., FIG. 2) may be located in the data transmission path to perform, without limitation, decoding, sharpening, image quality processing, post-processing, or the like.

An operation of each of the hardware modules is determined according to hardware design and may thus transform data according to a method determined during the manufacture of the hardware modules. Thus, when only the hardware modules are located in the data transmission path, data may not be transformed in various ways.

To this end, the DSP system 100 may be provided in the data transmission path. The DSP system 100 may transform input data in various ways according to a newly updated application. Thus, the DSP system 100 may have a high degree of freedom in transforming data.

Referring to FIG. 1, when the DSP system 100 is provided between the second hardware module and the fourth hardware module, data output from the second hardware module may be transformed by the DSP system 100 and be then transmitted to the fourth hardware module. In this case, the DSP system 100 may transform the data according to a newly updated application and thus the data may be efficiently transmitted.

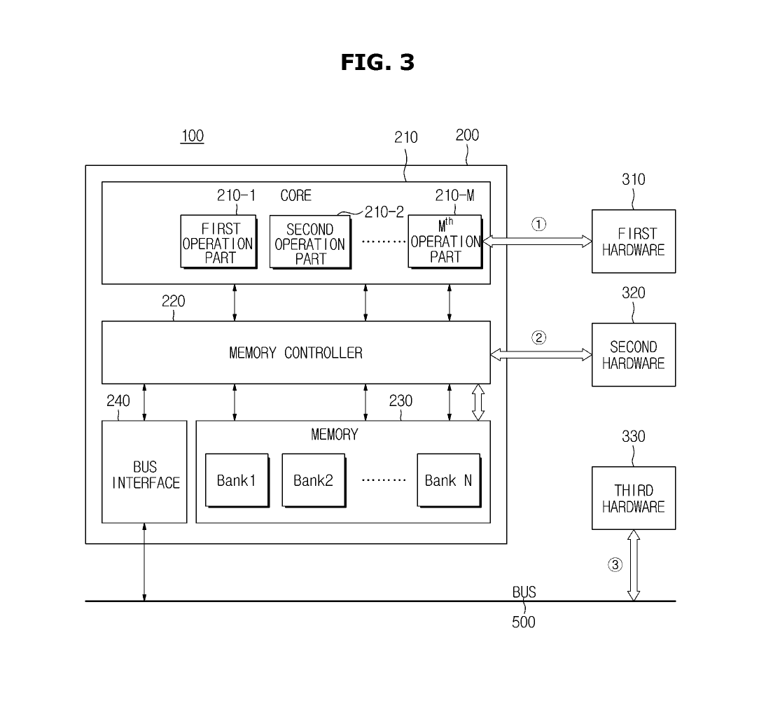

FIG. 2 is a block diagram illustrating a general DSP system. FIG. 3 is a block diagram illustrating an example method of sharing data between a DSP and a hardware device in the general DSP system.

Referring to FIG. 2, a general DSP system 100 may include a DSP 200, the hardware device 300, a bus, and a dynamic random access memory (DRAM) 400. Here, the hardware device 300 may be understood to include the hardware modules of FIG. 1 and a hardware accelerator which undertakes some of operations performed by the DSP 200.

The DRAM 400 may be connected to the DSP 200 via the bus. An instruction may be stored in the DRAM 400. The DSP 200 may receive the stored instruction via the bus. The DSP 200 may perform an operation on data according to the instruction. To this end, the DSP 200 may include a bus interface 240 connected to the bus, a memory 230 which stores data, a memory controller 220 which controls the data stored in the memory 230, and a core 210 which performs an operation on the data.

The bus interface 240 may receive an instruction and provide the instruction to the memory controller 220. The memory controller 220 may read data corresponding to the instruction from the memory 230, and provide the data to the core 210. The core 210 may transform the data received from the memory controller 220 by performing an operation on the data. The core 210 may include, for example, a first operation part 210-1, second operation part 210-2 to Mth operation part 210-M.

In this case, the hardware device 300 may perform an operation on some of the data to accelerate the performing of the operation by the DSP 200. To this end, the DSP 200 may share the data with the hardware device 300.

To share the data, the DSP 200 and the hardware device 300 may employ at least one of three methods to be described below.

In one of these methods, the core 210 of the DSP 200 and the hardware device 300 may be directly connected to each other. Referring to \hat{1} of FIG. 3, a first hardware device 310 may be directly connected to the core 210 of the DSP 200. Since data is transmitted directly by the hardware device 300 and the core 210 of the DSP 200, the speed of transmitting the data is high. However, this method cannot be employed when a series of operations are generally performed by the core 210.

For example, this method cannot be applied when an operation needs to be performed on intermediate data as in a two-dimensional (2D) filter.

In another method of these methods, the hardware device 300 may be connected to the memory 230 of the DSP 200. Referring to \hat{2} of FIG. 3, a second hardware device 320 may be connected to the memory 230 through the memory controller 220 of the DSP 200. In this case, a data transmission speed may be lower than that in the method in which the hardware device 300 is directly connected to the core 210. However, in this method, data may be transformed in various ways according to an application by the memory controller 220 storing the data in the memory 230, providing the stored data to the core 210, and storing the data transformed by the core 210 in the memory 230 again.

In the other method, the hardware device 300 and the DSP 200 are connected to each other via the bus. Referring to \hat{3} of FIG. 3, a third hardware device 330 may be connected to the bus interface 240 of the DSP 200 via the bus. In this method, a data transmission speed is lower than those in the above-described two methods but transforming of data may not be limited.

The hardware device 300 may be connected to the DSP 200 by employing an appropriate method among these methods according to data to be transformed. As a result, the connection of the hardware device 300 to the DSP 200 may be understood to mean that the hardware device 300 is connected to the core 210, that the hardware device 300 is connected to the memory 230, or that the hardware device 300 is connected to the bus.

An interconnection between the hardware device 300 and the DSP 200 is determined during designing of the hardware device 300 and thus the flexibility of data transformation may be low. For example, even if data needs to be transformed quickly using the second hardware device 320 of FIG. 3, the second hardware device 320 should first store the data in the memory 230 and then transmit the data to the core 210.

When a new hardware device 300 is added, the entire DSP system 100 should be newly designed. Furthermore, when an application is not determined during designing of the DSP system 100, an optimum design for data transmission may not be provided.

To solve this problem, the DSP system 100 in accordance with an embodiment includes a DSP interface apparatus 600 to variably set an interconnection between the DSP 200 and a plurality of hardware devices 300.

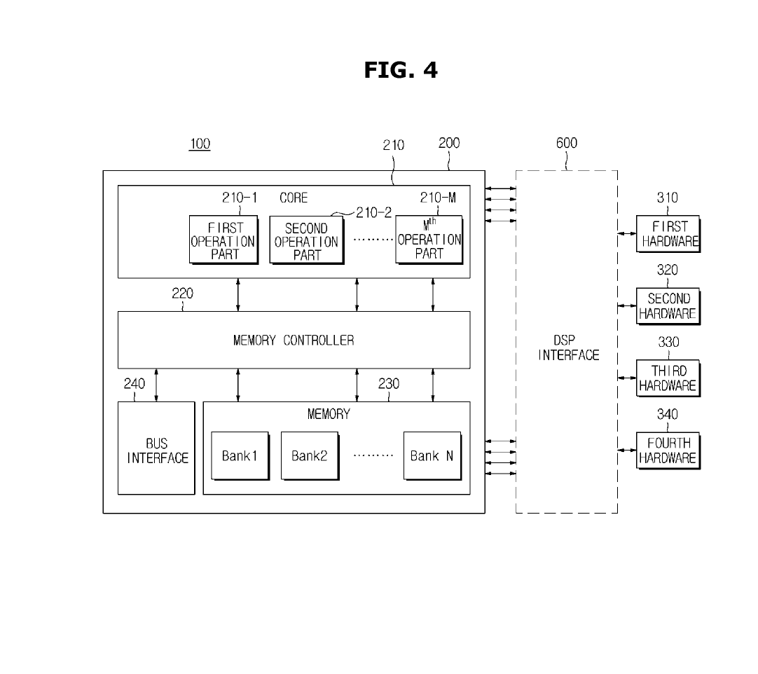

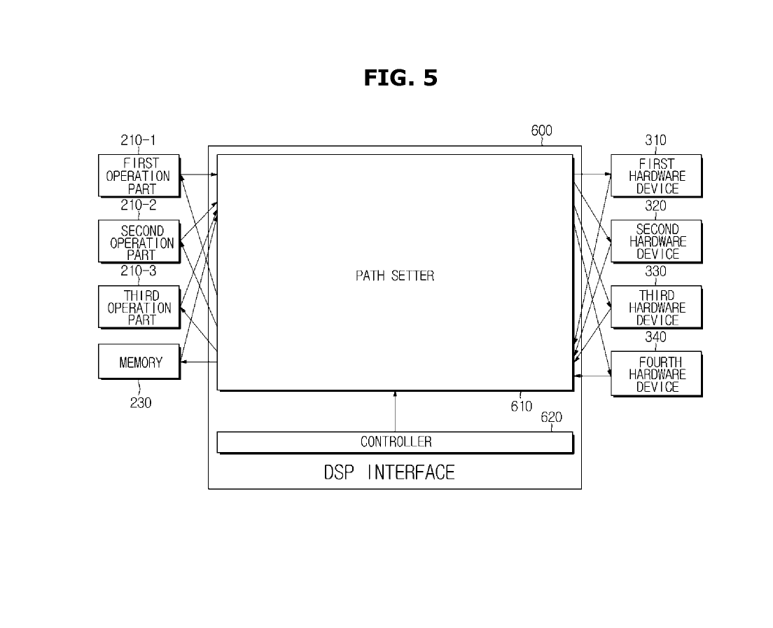

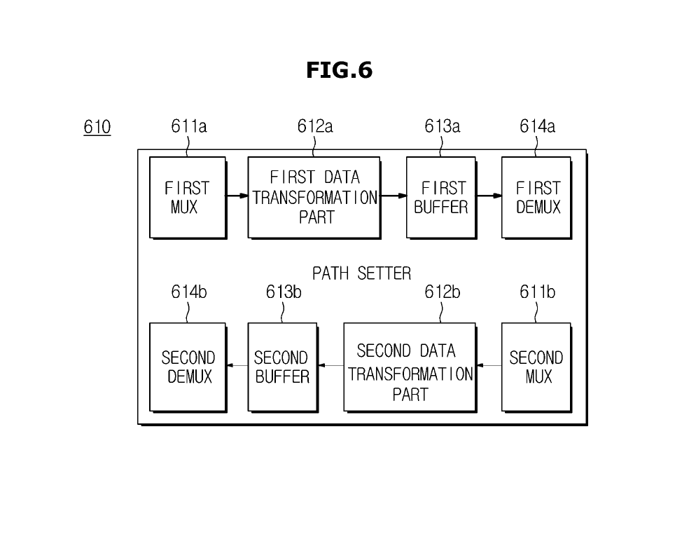

FIG. 4 is a block diagram illustrating an example DSP system having a DSP interface apparatus in accordance with an example embodiment. FIG. 5 is a block diagram illustrating an example operation of the DSP interface apparatus in accordance with an example embodiment. FIG. 6 is a block diagram illustrating an example path setter of the DSP interface apparatus in accordance with an example embodiment.

Referring to FIG. 4, the first to fourth hardware devices 310, 320, 330, and 340 are connected to the DSP 200 via the DSP interface apparatus 600, unlike in FIG. 2. As described above, an application appropriate when the hardware device 300 is directly connected to the core 210 and an application appropriate when the hardware device 300 is connected to the memory 230 are different from each other. Thus, the DSP interface apparatus 600 may variably set a data transmission path between the hardware device 300 and the core 210 or a data transmission path between the hardware device 300 and the memory 230 to optimize and/or improve a data transmission speed.

To this end, the DSP interface apparatus 600 may include a path setter (e.g., including path setting circuitry) 610 for setting a data transmission path between at least one among a plurality of hardware devices 300 and the DSP 200, and a controller 620 for controlling the path setter 610 to set a data transmission path according to predetermined configuration information.

Referring to FIG. 5, a first operation part 210-1, a second operation part 210-2, and a third operation part 210-3 of the core 210 of the DSP 200 and the memory 230 of the DSP 200 may be connected to the path setter 610. The first to fourth hardware devices 310, 320, 330, and 340 may be connected to the path setter 610. The path setter 610, under the control of the controller 620, may form a data transmission path by connecting at least one of the first to fourth hardware devices 310 to 340 and at least one of the first to third operation parts 210-1 to 210-3 and the memory 230 to each other.

For example, the path setter 610 may form a first transmission path through which data is transmitted to at least one of the first to fourth hardware devices 310, 320, 330, and 340 from at least one of the first to third operation parts 210-1 to 210-3 and the memory 230, and a second transmission path through which data is transmitted from at least one of the first to fourth hardware devices 310, 320, 330, and 340 to at least one of the first to third operation parts 210-1 to 210-3 and the memory 230.

To this end, referring to FIG. 6, the path setter 610 may include a first multiplexer (MUX) 611a provided in the first transmission path to selectively output a piece of data among data received from at least one of the plurality of operation parts and the memory 230 of the DSP 200, a first demultiplexer (DEMUX) 614a provided in the first transmission path to transmit the data output from the first MUX 611a to at least one of the plurality of hardware devices 300, a second MUX 611b provided in the second transmission path to selectively output a piece of data among data received from the plurality of hardware devices 300, and a second DEMUX 614b provided in the second transmission path to transmit the data output from the second MUX 611b to at least one of the plurality of operation parts and the memory 230 of the DSP 200.

As a result, the path setter 610 may form the first transmission path connecting at least one of the first to third operation parts 210-1 to 210-3 and the memory 230 selected by the first MUX 611a and at least one of the first to fourth hardware devices 310, 320, 330, and 340 selected by the first DEMUX 614a. Furthermore, the path setter 610 may form the second transmission path connecting at least one of the first to fourth hardware devices 310, 320, 330, and 340 selected by the second MUX 611b and at least one of the first to third operation parts 210-1 to 210-3 and the memory 230 selected by the second DEMUX 614b.

The path setter 610 may include a first data transformation part (e.g., including data transformation circuitry) 612a for transforming data transmitted through the first transmission path, a first buffer 613a for storing the data transmitted through the first transmission path, a second data transformation part (e.g., including data transformation circuitry) 612b for transforming data transmitted through the second transmission path, and a second buffer 613b for storing the data transmitted through the second transmission path.

The first data transformation part 612a and the second data transformation part 612b may perform simple transformation, e.g., addition, subtraction, multiplication, shifting, etc., on data transmitted through a transmission path. Thus, workload on the DSP 200 and/or the hardware device 300 may be decreased to increase a data transmission speed.

The first buffer 613a and the second buffer 613b may temporarily store data transformed as described above. Thus, data transmission synchronization may be performed and data may be simply transformed. For example, the first buffer 613a and the second buffer 613b may store a predetermined size of data and provide it through a transmission path to change the size of the data.

FIG. 6 illustrates an example case in which the first buffer 613a and the first data transformation part 612a are provided in the first transmission path set by the path setter 610, and the second buffer 613b and the second data transformation part 612b are provided in the second transmission path set by the path setter 610. However, the path setter 610 may not include any buffer and any data transformation part. For example, the first transmission path may be set by connecting an input terminal of the first DEMUX 614a to an output terminal of the first MUX 611a, and the second transmission path may be set by connecting an input terminal of the second DEMUX 614b to an output terminal of the second MUX 611b.

Although FIG. 6 illustrates an example case in which the path setter 610 sets one first transmission path and one second transmission path, the path setter 610 may set a plurality of first transmission paths and/or a plurality of second transmission paths. In order to set the plurality of first transmission paths, the path setter 610 may include a plurality of first MUXs 611a and a plurality of first DEMUXs 614a, and may further include a plurality of first data transformation parts 612a and a plurality of first buffers 613a. Furthermore, in order to set the plurality of second transmission paths, the path setter 610 may include a plurality of second MUXs 611b and a plurality of second DEMUXs 614b, and may further include a plurality of second data transformation parts 612b and a plurality of second buffers 613b.

Referring back to FIG. 5, the controller 620 may include various processing circuitry and control the path setter 610 to set a data transmission path based on predetermined configuration information. In this case, the configuration information may be understood to include various types of information input from the outside to set a data transmission path. For example, the configuration information may include information regarding the complexity of an operation to be performed on data transmitted, information regarding priorities assigned to the plurality of hardware devices 300, information regarding the type of data transmitted through a transmission path, and information regarding whether data is to be transmitted bidirectionally.

The controller 620 may determine whether the hardware device 300 connected to the DSP interface apparatus 600 is to be connected to the plurality of operation parts of the core 210 or the memory 230 based on the information regarding the complexity of the operation which is included in the configuration information. Here, the complexity of the operation may be a value obtained by quantifying a time period needed for the plurality of operation parts of the core 210 to perform the operation on target data. The controller 620 may check the complexity of the operation, and control the path setter 610 to form a transmission path with an optimum operation speed when the operation is performed, according to the complexity of the operation.

The controller 620 may control the second MUX 611b based on the information regarding the priorities assigned to the plurality of hardware devices 300 which is included in the configuration information. In detail, the controller 620 may control the second MUX 611b to first connect the hardware device 300 with high priority to the DSP 200. Thus, the path setter 610 may sequentially connect the plurality of hardware devices 300 in the data transmission path according to priority.

The controller 620 may determine whether the hardware device 300 connected to the DSP interface apparatus 600 is to be connected to the plurality of operation parts of the core 210 or the memory 230 based on the information regarding the type of data included in the configuration information. The controller 620 may check an application to be applied based on the type of the data, and control the path setter 610 to form a transmission path with an optimum transmission speed when an operation is to be performed according to the application.

The controller 620 may determine whether data is to be transmitted bidirectionally using both the first transmission path and the second transmission path set by the path setter 610 based on the information regarding whether data is to be transmitted bidirectionally which is included in configuration information. Since the first transmission path and the second transmission path are formed to be independent from each other, the controller 620 may control the path setter 610 to transmit data using one or both of the first and second transmission paths according to the determination as to whether data is to be transmitted bidirectionally.

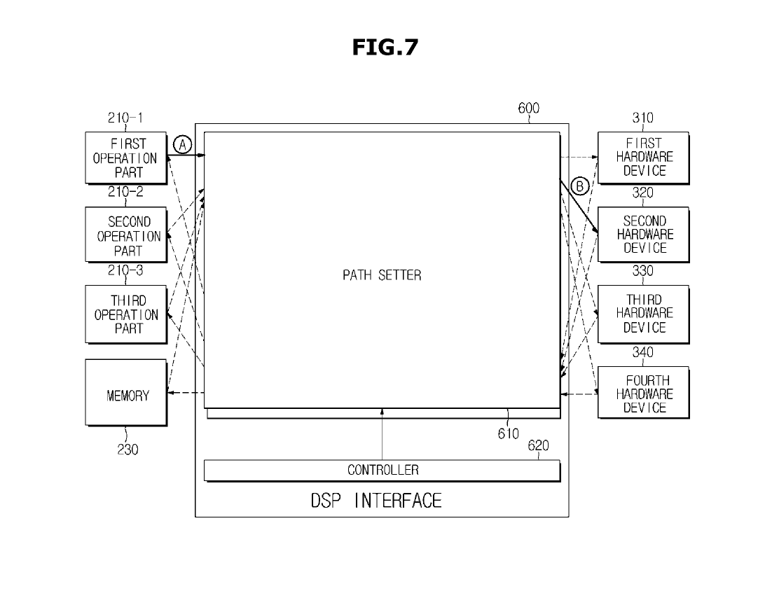

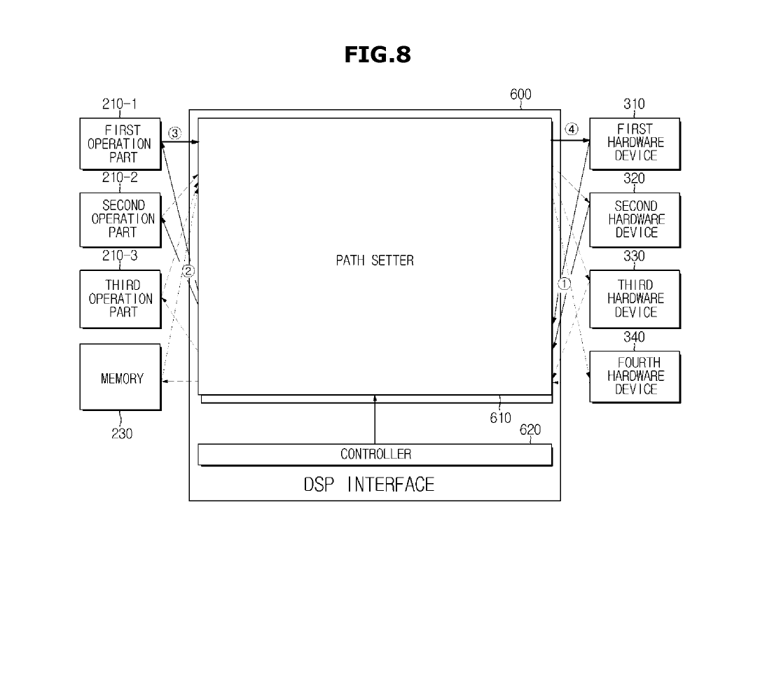

A data transmission method performed by the DSP interface apparatus 600 will be described with reference to FIGS. 7 and 8 below.

FIG. 7 is a diagram illustrating an example data transmission method, performed by a DSP interface apparatus, in accordance with an example embodiment. FIG. 8 is a diagram illustrating an example data transmission method, performed by a DSP interface apparatus, in accordance with another example embodiment. In FIGS. 7 and 8, broken lines may represent paths which data may be transmitted through but are not connected, and continuous lines may represent a path which is connected to transmit data therethrough.

FIG. 7 illustrates a case in which the DSP interface apparatus 600 conducts data transmission in one direction. Referring to FIG. 7, the DSP interface apparatus 600 may be connected to the first operation part 210-1 to form a path Â and may be connected to the second hardware device 320 to form a path \hat{B} according to configuration information. Thus, the DSP interface apparatus 600 may form a first transmission path through which data transformed by the first operation part 210-1 is transmitted to the second hardware device 320 via the paths Â and \hat{B}.

On the other hand, the DSP interface apparatus 600 may transmit data bidirectionally. FIG. 8 illustrates a case in which the DSP interface apparatus 600 transmits data bidirectionally. Referring to FIG. 8, the DSP interface apparatus 600 may be connected to the first hardware device 310 and the second hardware device 320 to form a path \hat{1} and may be connected to the first operation part 210-1 and the second operation part 210-2 to form a path \hat{2} according to the configuration information. Thus, the DSP interface apparatus 600 may form a second transmission path through which data transformed by the first hardware device 310 and the second hardware device 320 is transmitted to the first operation part 210-1 and the second operation part 210-2 via the paths \hat{1} and \hat{2}.

At the same time, the DSP interface apparatus 600 may be connected to the first operation part 210-1 to form a path \hat{3} and be connected to the first hardware device 310 to form a path \hat{4} according to the configuration information. Thus, the DSP interface apparatus 600 may form a first transmission path through which data transformed by the first operation part 210-1 is transmitted to the first hardware device 310 via the paths \hat{3} and \hat{4}.

As described above, the DSP interface apparatus 600 may transmit data by independently using the first transmission path and the second transmission path.

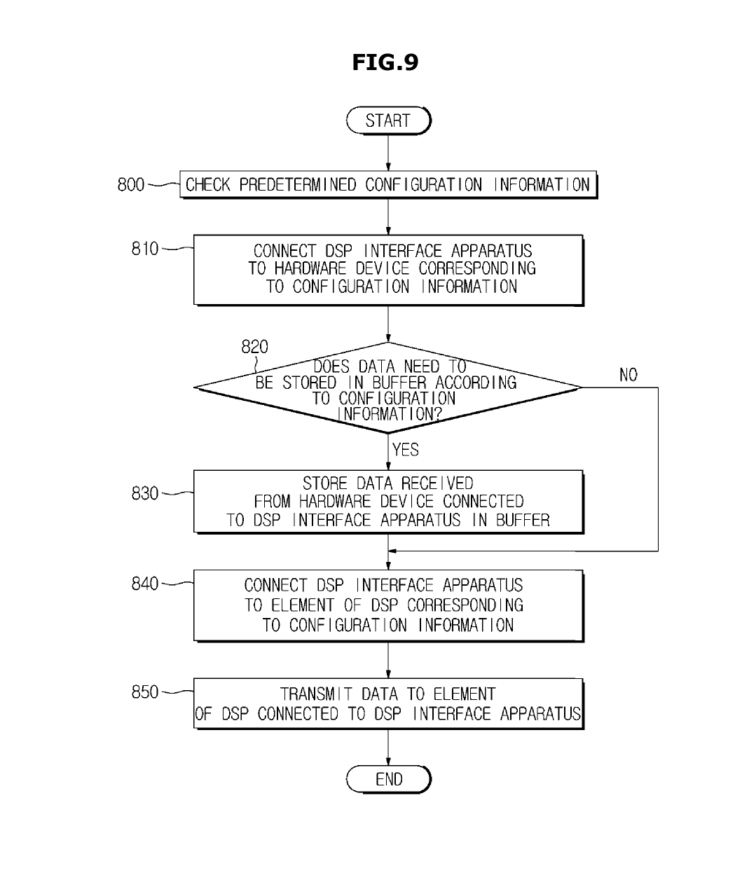

FIG. 9 is a flowchart illustrating an example method of controlling a DSP interface apparatus in accordance with an example embodiment. FIG. 9 relates to a method of transmitting data through a second transmission path.

The DSP interface apparatus 600 may check predetermined configuration information (800). In this case, the configuration information may be understood to include various types of information input from the outside to set a data transmission path. For example, the configuration information may include information regarding priorities assigned to a plurality of hardware devices 300, the type of data transmitted through a transmission path, and whether data is to be transmitted bidirectionally.

The DSP interface apparatus 600 may be connected to the hardware device 300 corresponding to the configuration information (810). For example, the DSP interface apparatus 600 may be connected to the hardware device 300 by referring to the information regarding the priorities assigned to the plurality of hardware devices 300 which is included in the configuration information.

When the DSP interface apparatus 600 is connected to the hardware device 300, the DSP interface apparatus 600 may check whether data needs to be stored in a buffer according to the configuration information (820). When data needs to be stored in the buffer, the DSP interface apparatus 600 may store data received from the hardware device 300 connected thereto in the buffer (830). By using the buffer, data transmission synchronization may be performed and data may be simply transformed.

The DSP interface apparatus 600 may be connected to an element of the DSP 200 corresponding to the configuration information after the data is stored in the buffer or when the data need not be stored in the buffer (840). Here, the element of the DSP 200 may be understood to include at least one among the plurality of operation parts of the core 210 of the DSP 200 and the memory 230 of the DSP 200. Accordingly, the second transmission path may be formed.

The DSP interface apparatus 600 may transmit the data to the element of the DSP 200 connected thereto through the second transmission path (850).

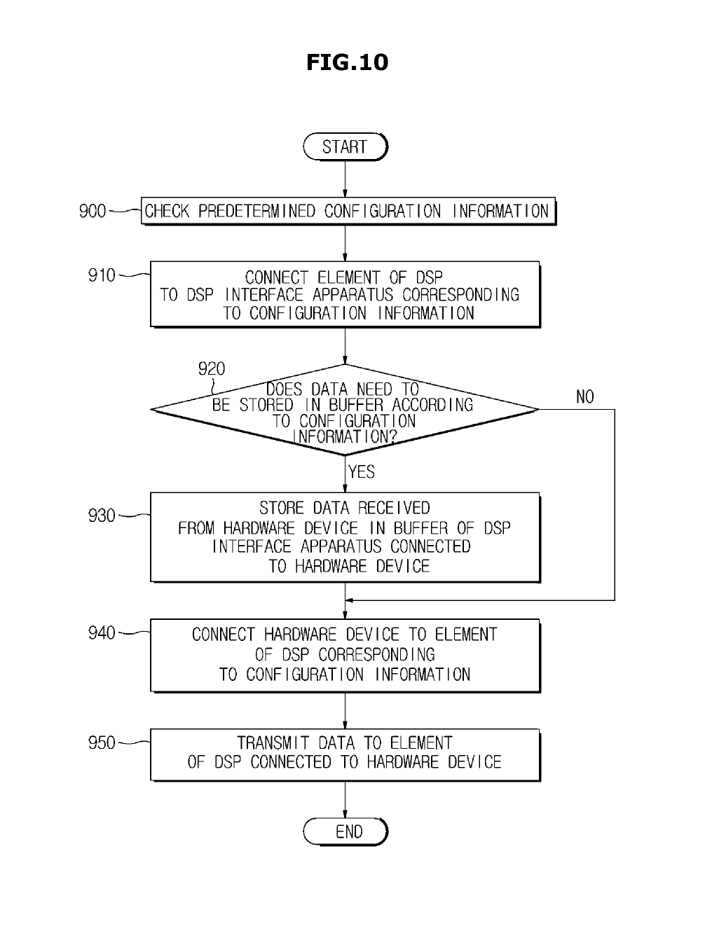

FIG. 10 is a flowchart illustrating an example method of controlling the DSP interface apparatus 600 in accordance with another example embodiment. FIG. 10 relates to a method of transmitting data through a first transmission path.

The DSP interface apparatus 600 may check predetermined configuration information (900). In this case, the configuration may be understood to include various types of information input from the outside to set a data transmission path. For example, the configuration information may include information regarding priorities assigned to a plurality of hardware devices 300, the type of data transmitted through a transmission path, and whether data is to be transmitted bidirectionally.

The DSP interface apparatus 600 may be connected to an element of the DSP 200 corresponding to the configuration information (910). Here, the element of the DSP 200 may be understood to include at least one of the plurality of operation parts of the core 210 of the DSP 200 and the memory 230 of the DSP 200.

When the DSP interface apparatus 600 is connected to the element of the DSP 200, the DSP interface apparatus 600 may check whether data needs to be stored in a buffer according to the configuration information (920). When data needs to be stored in the buffer, the DSP interface apparatus 600 may store data received from the hardware device 300 connected thereto in the buffer (930). By using the buffer, data transmission synchronization may be performed and data may be simply transformed.

The DSP interface apparatus 600 may be connected to the hardware device 300 corresponding to the configuration information after the data is stored in the buffer or when the data need not be stored in the buffer (940). In detail, the DSP interface apparatus 600 may be connected to the hardware device 300 by referring to the information regarding the priorities assigned to the plurality of hardware devices 300 which is included in the configuration information. Accordingly, the first transmission path may be formed.

The DSP interface apparatus 600 may transmit data to the element of the DSP connected to the hardware device 300 connected thereto through the first transmission path (950).

According to the present disclosure, in a DSP interface apparatus and a method of controlling the same in accordance with an example embodiment, data transmission efficiency may be increased by setting a data transmission path to correspond to the types and number of hardware devices connected to a DSP.

Although various example embodiments of the present disclosure have been illustrated and described, it will be appreciated by those skilled in the art that changes may be made in these embodiments without departing from the principles and spirit of the disclosure, the scope of which is defined in the appended claims and their equivalents.

What is claimed is:

1. A digital signal processor (DSP) interface apparatus comprising:
a path setter configured to set a data transmission path between at least one of a plurality of hardware devices and a DSP; and
a controller configured to control the path setter to set the data transmission path by connecting at least one of a plurality of operation parts and a memory of the DSP and at least one of the plurality of hardware devices based on predetermined configuration information.

2. The DSP interface apparatus according to claim 1, wherein the controller is configured to control the path setter to set the data transmission path using the configuration information, the configuration information including at least one of: information regarding complexity of an operation to be performed on data transmitted, information regarding priorities assigned to the plurality of hardware devices, information regarding type of the data transmitted, and information regarding whether data is to be transmitted bidirectionally.

3. The DSP interface apparatus according to claim 2, wherein the controller is configured to control the path setter to connect at least one of the plurality of hardware devices to either at least one of the plurality of operation parts of the DSP or the memory based on the complexity of the operation.

4. The DSP interface apparatus according to claim 2, wherein the controller is configured to control the path setter to sequentially connect the plurality of hardware devices to the data transmission path based on the priorities assigned to the plurality of hardware devices.

5. The DSP interface apparatus according to claim 1, wherein the path setter is configured to set a first transmission path through which data is transmitted from the DSP to at least one of the plurality of hardware devices, and to set a second transmission path through which data is transmitted from at least one of the plurality of hardware devices to the DSP.

6. The DSP interface apparatus according to claim 5, wherein the path setter comprises:
a first multiplexer configured to selectively output a piece of data from among data received from at least one of the plurality of operation parts and the memory of the DSP, the first multiplexer being provided in the first transmission path;
a first demultiplexer configured to transmit the data output from the first multiplexer to at least one of the plurality of hardware devices, the first demultiplexer being provided in the first transmission path;
a second multiplexer configured to selectively output a piece of data from among data received from at least one of the plurality of hardware devices, the second multiplexer being provided in the second transmission path; and
a second demultiplexer configured to transmit the data output from the second multiplexer to at least one of the plurality of operation parts and the memory of the DSP, the second demultiplexer being provided in the second transmission path.

7. The DSP interface apparatus according to claim 5, wherein the path setter comprises:
a first buffer configured to store data transmitted through the first transmission path; and
a second buffer configured to store data transmitted through the second transmission path.

8. The DSP interface apparatus according to claim 7, wherein the controller is configured to control at least one of: the first buffer and the second buffer to change a size of the transmitted data.

9. The DSP interface apparatus according to claim 5, wherein the path setter comprises:
a first data transformation part configured to transform data transmitted through the first transmission path; and
a second data transformation part configured to transform data transmitted through the second transmission path.

10. The DSP interface apparatus according to claim 5, wherein the controller is configured to control the path setter to set a plurality of first transmission paths and a plurality of second transmission paths, a plurality of first transmission paths and a second transmission path, or a first transmission path and a plurality of second transmission paths.

11. A method of controlling a digital signal processor (DSP) interface apparatus for setting a data transmission path between at least one of a plurality of hardware devices and a DSP, the method comprising:
setting the data transmission path by connecting at least one of a plurality of operation parts and a memory of the DSP and at least one of the plurality of hardware devices based on predetermined configuration information; and
transmitting data through the set data transmission path.

12. The method according to claim 11, wherein the setting of the data transmission path comprises setting the data transmission path using the configuration information, the configuration information including at least one of:
information regarding complexity of an operation to be performed on data transmitted, information regarding priorities assigned to the plurality of hardware devices, information regarding type of the data transmitted, and information regarding whether data is to be transmitted bidirectionally.

13. The method according to claim 12, wherein the setting of the data transmission path comprises connecting at least one of the plurality of hardware devices to either at least one of the plurality of operation parts of the DSP or the memory based on the complexity of the operation.

14. The method according to claim 12, wherein the setting of the data transmission path comprises sequentially connecting the plurality of hardware devices to the data transmission path based on the priorities assigned to the plurality of hardware devices.

15. The method according to claim 11, wherein the setting of the data transmission path comprises setting a first transmission path through which data is transmitted from the DSP to at least one of the plurality of hardware devices, and a second transmission path through which data is transmitted from at least one of the plurality of hardware devices to the DSP.

16. The method according to claim 15, wherein the setting of the data transmission path comprises:
selectively outputting a piece of data from among data received from at least one of the plurality of operation parts and the memory of the DSP using a first multiplexer provided in the first transmission path;
transmitting the data output from the first multiplexer to at least one of the plurality of hardware devices using a first demultiplexer provided in the first transmission path;
selectively outputting a piece of data from among data received from at least one of the plurality of hardware devices using a second multiplexer provided in the second transmission path; and
transmitting the data output from the second multiplexer to at least one of the plurality of operation parts and the memory of the DSP using a second demultiplexer provided in the second transmission path.

17. The method according to claim 14, wherein the transmitting of the data comprises transforming data transmitted through the transmission path.

18. The method according to claim 17, wherein the transforming of the transmitted data comprises changing a size of the transmitted data by storing the transmitted data.

19. The method according to claim 17, wherein the transforming of the transmitted data comprises:
transforming data transmitted through a first transmission path using a first data transformation part provided in the first transmission path; and
transforming data transmitted through a second transmission path using a second data transformation part provided in the second transmission path.

20. The method according to claim 14, wherein the setting of the data transmission path comprises setting a plurality of first transmission paths and a plurality of second transmission paths, a plurality of first transmission paths and a second transmission path, or a first transmission path and a plurality of second transmission paths.
